(19) United States
(12) Patent Application Publication
(10) Pub. No.: US 2025/0201255 A1
(43) Pub. Date: Jun. 19, 2025

(54) CONTENT-BASED SWITCHABLE AUDIO CODEC

(71) Applicant: QUALCOMM Incorporated, San Diego, CA (US)

(72) Inventors: Pravin Kumar RAMADAS, San Diego, CA (US); Vivek RAJENDRAN, San Diego, CA (US); Duminda DEWASURENDRA, San Diego, CA (US); Stephane VILLETTE, San Diego, CA (US)

(21) Appl. No.: 18/538,006

(22) Filed: Dec. 13, 2023

(51) Int. Cl. G10L 19/04; G10L 19/00

(52) U.S. Cl. CPC G10L 19/04; G10L 19/0017

(57) ABSTRACT

A device includes a machine-learning audio encoder and a waveform-matching audio encoder. The device includes a controller configured to cause a segment of audio data to be input to the machine-learning audio encoder, to the waveform-matching audio encoder, or to both, based on a classification associated with the segment.

### I. FIELD

The present disclosure is generally related to content-based switchable audio codecs.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Many common uses of such devices revolve around media (e.g., audio, video, games, extended reality, etc.), such as uses that involved the capture, communication, and/or reproduction of media content. Taking audio data as an example, digitization, storage, and communication of audio data is challenging because high fidelity reproduction of sound is generally desirable (e.g., to improve the user experience), but increasing sound reproduction fidelity may entail the use of more bits to represent the audio content and/or increased computational complexity to process the audio data. Increased computational complexity requires more power, more processing resources, more memory, or all three. Increasing the number of bits used to represent the audio content increases bandwidth required to transmit the audio data and/or memory required to store the audio data.

Encoding schemes are often used to process audio data to reduce the number of bits needed to represent particular audio content. While many encoding techniques can retain sound reproduction fidelity while decreasing the number of bits needed to represent the audio content, such techniques introduce additional computational complexity. Thus, it is challenging to encode audio data in resource constrained use cases, such as on mobile computing devices that rely on battery power.

### III. SUMMARY

According to one implementation of the present disclosure, a device includes a machine-learning audio encoder and a waveform-matching audio encoder. The device includes a controller configured to cause a segment of audio data to be input to the machine-learning audio encoder, to the waveform-matching audio encoder, or to both, based on a classification associated with the segment.

According to another implementation of the present disclosure, a method includes obtaining, by one or more processors, an indication of a type of audio content associated with a segment of audio data. The method includes selectively, based on the indication, causing the segment to be sent as input to a machine-learning audio encoder, a waveform-matching audio encoder, or both.

According to another implementation of the present disclosure, a non-transitory computer-readable medium stores instructions that are executable by one or more processors to cause the one or more processors to obtain an indication of a type of audio content associated with a segment of audio data. The instructions further cause the one or more processors to selectively, based on the indication, cause the segment to be sent as input to a machine-learning audio encoder, a waveform-matching audio encoder, or both.

According to another implementation of the present disclosure, an apparatus includes means for obtaining an indication of a type of audio content associated with a segment of audio data. The apparatus includes means for selectively, based on the indication, causing the segment to be sent as input to a machine-learning audio encoder, a waveform-matching audio encoder, or both.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system including a content-switchable audio coder, in accordance with some examples of the present disclosure.

FIG. 2 is a diagram of an illustrative aspect of operations associated with the system of FIG. 1, in accordance with some examples of the present disclosure.

FIG. 3 is a diagram of an illustrative aspect of operations associated with the system of FIG. 1, in accordance with some examples of the present disclosure.

FIG. 4 is a diagram of an illustrative aspect of operations associated with the system of FIG. 1, in accordance with some examples of the present disclosure.

FIG. 5 is a table of an illustrative aspect of operations associated with the system of FIG. 1, in accordance with some examples of the present disclosure.

FIG. 6 is a diagram of an illustrative aspect of operations associated with the system of FIG. 1, in accordance with some examples of the present disclosure.

FIG. 7 is a diagram of an illustrative aspect of operations associated with the system of FIG. 1, in accordance with some examples of the present disclosure.

FIG. 8 is a diagram of an example of an integrated circuit operable to switch audio codecs based on content of one or more segments of audio data, in accordance with some examples of the present disclosure.

FIG. 9 is a diagram of a mobile device operable to switch audio codecs based on content of one or more segments of audio data, in accordance with some examples of the present disclosure.

FIG. 10 is a diagram of a headset operable to switch audio codecs based on content of one or more segments of audio data, in accordance with some examples of the present disclosure.

FIG. 11 is a diagram of a wearable electronic device operable to switch audio codecs based on content of one or more segments of audio data, in accordance with some examples of the present disclosure.

FIG. 12 is a diagram of a voice-controlled speaker system operable to switch audio codecs based on content of one or more segments of audio data, in accordance with some examples of the present disclosure.

FIG. 13 is a diagram of a camera operable to switch audio codecs based on content of one or more segments of audio data, in accordance with some examples of the present disclosure.

FIG. 14 is a diagram of a headset, such as a virtual reality, mixed reality, or augmented reality headset, operable to switch audio codecs based on content of one or more segments of audio data, in accordance with some examples of the present disclosure.

FIG. 15 is a diagram of a first example of a vehicle operable to switch audio codecs based on content of one or more segments of audio data, in accordance with some examples of the present disclosure.

FIG. 16 is a diagram of a mixed reality or augmented reality glasses device operable to switch audio codecs based on content of one or more segments of audio data, in accordance with some examples of the present disclosure.

FIG. 17 is a diagram of earbuds operable to switch audio codecs based on content of one or more segments of audio data, in accordance with some examples of the present disclosure.

FIG. 18 is a diagram of a hearing aid device operable to switch audio codecs based on content of one or more segments of audio data, in accordance with some examples of the present disclosure.

FIG. 19 is a diagram of a second example of a vehicle operable to switch audio codecs based on content of one or more segments of audio data, in accordance with some examples of the present disclosure.

FIG. 20 is a diagram of a particular implementation of a method of switching audio codecs based on content of one or more segments of audio data that may be performed by the system of FIG. 1, in accordance with some examples of the present disclosure.

FIG. 21 is a block diagram of a particular illustrative example of a device that is operable to switch audio codecs based on content of one or more segments of audio data, in accordance with some examples of the present disclosure.

### V. DETAILED DESCRIPTION

Machine-learning-based audio codecs can be trained to encode audio data representing particular types of audio content, such as speech, in a manner that is more efficient (in terms of compression ratio, e.g., number of bits used to represent a particular segment of audio data) than traditional codecs without loss of quality. One example of such a machine-learning-based audio codec is the Lyra codec. The Lyra codec uses a recurrent neural network to quantize audio data representing speech at a low bitrate and uses a generative neural network to decode the quantized audio data to generate output representing the speech. The Lyra codec is able to achieve a high compression ratio for audio representing speech and provides high-quality decoded speech output. However, the Lyra codec and other similar codecs trade off generality to achieve such bit efficiency and high-quality speech reproduction. For example, while the Lyra codec performs well when provided audio data representing speech, it is not able to achieve the same performance when provided audio data representing other types of audio content, such as music.

Other more generalized machine-learning-based audio codecs, such as the SoundStream codec, are able to provide high quality audio reproduction, but at the cost of decreased compression ratio as compared to the more specialized audio codecs targeting a particular audio type (e.g., Lyra, which targets speech data). Further, such generalized machine-learning-based audio codecs tend to be much larger (e.g., in terms of model parameters, and correspondingly, memory footprint) and more complex (e.g., more resource intensive to use), which makes them challenging to use in resource constrained use-cases, such as onboard mobile devices.

For audio streams that include various types of audio content (e.g., speech, noise, music, etc.) and audio streams where the audio content type is not known in advance, it is challenging to use machine-learning codecs since the quality of the generated audio output cannot be guaranteed unless one relies on less efficient, high memory footprint generalized machine-learning-based audio codecs. Thus, it is problematic to provide high-quality, low bitrate audio compression in resource constrained situations.

The above-described problems associated with providing high-quality, low-bit rate audio compression for resource constrained use cases and various types of audio data are solved using a content-based switchable coder system (also referred to herein as a “content-switchable coder system”) as described herein. The content-based switchable coder system includes a plurality of audio encoders and a controller that selectively provides segments of audio data to one or more of the audio encoders based on content (e.g., the type of audio data) represented in each segment. The plurality of audio encoders can include, for example, a machine-learning audio encoder that is particularly well-suited to encode a particular type of audio data, such as speech. In this example, the machine-learning audio encoder can provide a high compression ratio and high-quality audio reproduction for segments that include speech. The plurality of audio encoders can include at least one audio encoder that is more generalized to provide high-quality audio reproduction for many types of audio content, such as a waveform-matching audio encoder. In this context, a waveform-matching audio encoder refers to a coder that attempts to represent a segment of audio data in a manner that enables reproduction of the entire waveform of the segment (in contrast, for example, to coders that attempt to enable reproduction of only speech components of the segment).

The controller of the content-based switchable coder system can cause segments of audio data that include a target audio type (e.g. speech, wind noise, noise, music, silence, etc.) to be provided as input to a machine-learning audio encoder that is well suited to encode the target audio type and can cause other segments (e.g., segments that include non-target audio type(s)) to be provided as input to a waveform-matching audio encoder. The content-based switchable coder system can include an audio classifier that is configured to provide an indication to the controller of whether each segment of audio data includes target or non-target audio. For example, the classifier can be a machine-learning based classifier configured to generate a classification output associated with an input segment of audio data. The classification output can be binary (e.g., a first value, such as a one, to indicate that the segment includes a target audio type and a second value, such as a zero, to indicate that the segment does not include the target audio type). Alternatively, the classification output can indicate one of a plurality of classifications associated with the segment (e.g., speech, wind noise, music, silence, etc.). The classifier can use machine-learning techniques, can use procedural techniques (such as voice activity detection), or a combination thereof. To illustrate, multiple classification techniques can be used, and a voting or other selection mechanism can be used to generate an indication for the controller based on the various classification results from the multiple classification techniques.

The content-based switchable coder system thus enables high-quality, low-bit rate representation of target audio data (e.g., speech) without loss of quality for audio data segments that include non-target audio types. Further, the audio encoders used, e.g., a targeted machine-learning audio encoder and a general waveform-matching audio encoder, can have a smaller memory footprint and can be less resource intensive to use than general purpose machine-learning based audio encoders. Thus, the content-based switchable coder system is useable in resource-constrained use cases.

One problem that can arise due to switching between codecs is that such codec switching can introduce audio artifacts that reduce the overall quality of reproduced audio output. The content-based switchable coder system disclosed herein can use various switching techniques to mitigate introduction of such artifacts. For example, in some embodiments, when switching between coders, the content-based switchable coder system can provide one or more segments of audio data to both a machine-learning audio encoder and a waveform-matching audio encoder, and the output of each coder can be sent to a decoder system. In such embodiments, the decoder system can use a machine-learning audio decoder to decode the data from the machine-learning audio encoder to generate a first decoded representation of the segment and a waveform-matching decoder to decode the data from the waveform-matching audio encoder to generate a second decoded representation of the segment. The decoder system can combine portions of the first and second decoded representations to taper down from one coder while tapering up the other. To illustrate, when the switch is from the machine-learning audio encoder to the waveform-matching audio encoder, the decoder system can gradually de-emphasize (e.g., taper down) the first decoded representation and concurrently gradually emphasize (e.g., taper up) the second decoded representation to generate output audio. Combining decoded output data from two different coders in this manner blends the audio in a manner that reduces audio artifacts introduced by switching codecs.

Combining the decoded output data from two different coders as in the previous example increases the bit rate of data transmitted between the content-based switchable coder system and the decoder system since two representations of at least one audio data segment are sent to facilitate the blending. Additionally, providing a single segment to two different coders uses extra resources (e.g., processor time and power) at the content-based switchable coder system. In some embodiments, these problems are solved by providing each segment of audio data to only one of the audio encoders of the content-based switchable coder system. In such embodiments, the decoder system uses extrapolation techniques to blend adjacent segments from different coders. For example, blending techniques such as those used for frame error concealment can be used to ease the transition between codecs to reduce audio artifacts introduced by switching codecs. Such embodiments do not increase the bit rate of data transmitted between the content-based switchable coder system and the decoder system since only one representation of each audio data segment is used to perform the blending.

In some embodiments, the controller uses switching hysteresis to reduce audio artifacts introduced by switching codecs. For example, when switching from a machine-learning audio encoder to a waveform-matching audio encoder, the controller can switch without delay. In contrast, when switching from the waveform-matching audio encoder to the machine-learning audio encoder, the controller can introduce a switching delay that is based on content of the audio data segments. The waveform-matching audio encoder is generally able to encode various types of audio content without significant reduction in fidelity; however, it is often the case that a relatively short segment of non-target data can cause the machine-learning audio encoder to generate significant (e.g., audible to a user) artifacts. Additionally, switching to the machine-learning audio encoder between segments with certain sounds may cause more perceivable artifacts than switching between segments that represent other sounds or silence. To illustrate, artifacts can be introduced by switching to the machine-learning audio encoder in the middle of a vowel sound. Thus, the controller can delay switching from the waveform-matching audio encoder to the machine-learning audio encoder until the end of a vowel sound, until a period of silence, or until a low energy segment is received for coding.

In some embodiments, when switching from a first coder to a second coder, the controller populates coder state data of the second coder based on data from the first coder. For example, when switching from the machine-learning based coder to the waveform-matching audio encoder, the controller can populate excitation signal memories of the waveform-matching audio encoder based on data from the machine-learning coder, which provides a smoother pitch pulse sequence than initializing the excitation signal memories of the waveform-matching audio encoder using default data (e.g., zeros).

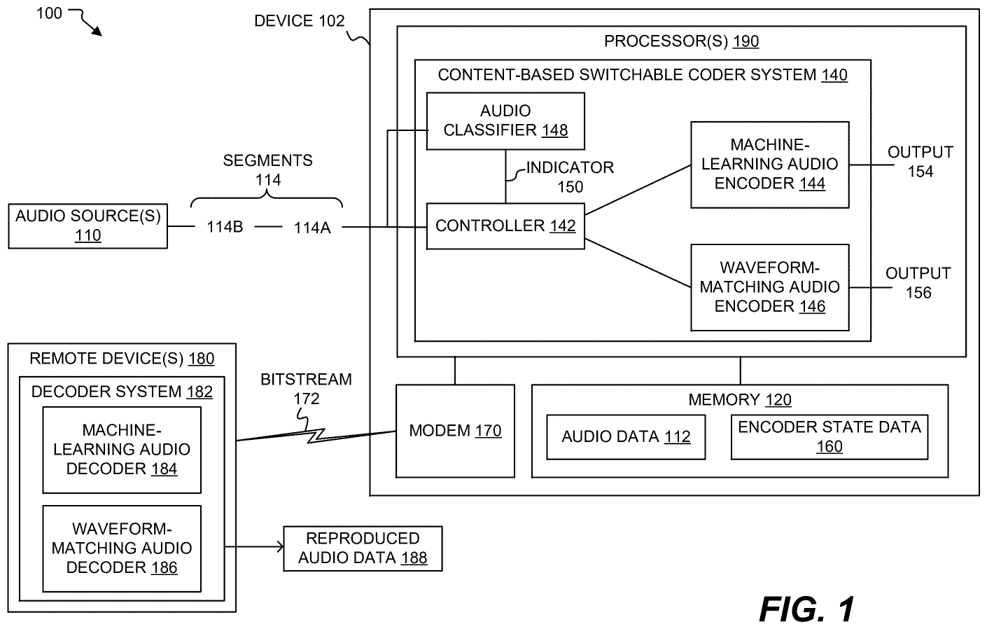

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple segments are illustrated and associated with reference numbers 114A and 114B. When referring to a particular one of these segments, such as a segment 114A, the distinguishing letter “A” is used. However, when referring to any arbitrary one of these segments or to these segments as a group, the reference number 114 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 shows a block diagram of a system 100 that illustrates aspects of a content-switchable codec. The system 100 includes a device 102 that includes content-switchable coder system 140. The content-switchable coder system 140 includes two or more audio encoders of different types and a controller 142 configured to selectively route segments 114 of audio data 112 to one or more of the audio encoders. In particular, the controller 142 selectively routes segments 114 of audio data 112 based on the audio content of each segment 114. Selectively routing a segment 114 based on the content of the segment 114 enables the content-switchable coder system 140 to efficiently (in terms of computing resources used and in terms of bit rate of the encoded data) encode the audio data 112 in a manner that provides high quality audio reproduction.

In FIG. 1, the device 102 is coupled to one or more audio source(s) 110. In some embodiments, one or more of the audio source(s) 110 are integrated within the device 102. For example, the audio source(s) 110 can include media files stored in a memory 120 of the device. As another example, the audio source(s) 110 can include one or more microphones integrated within or coupled to the device 102.

The audio data 112 includes a plurality of segments 114. In FIG. 1, the segments 114 include a segment 114A and a segment 114B, which represent adjacent segments 114 in a series of segments 114 in FIG. 1. Each segment 114 represents a time-windowed portion of the audio data 112. Optionally, in some embodiments, adjacent segments (e.g., the segment 114A and the segment 114B) of the series are partially overlapping. In some embodiments, each segment 114 includes pulse code modulation (PCM) data.

In FIG. 1, the two or more audio encoders of the content-switchable coder system 140 include at least a machine-learning audio encoder 144 and a waveform-matching audio encoder 146. The machine-learning audio encoder 144 is a machine-learning model (or a set of machine-learning models) configured and trained to generate low-bit rate, high quality representations of segments that include audio content of a target type, such as speech. For example, the machine-learning audio encoder 144 can include a neural homomorphic vocoder (NHV). In some embodiments, an NHV is based on a two-state excitation model of the human vocal tract, which enables the NHV to encode audio data representing speech with high-fidelity and a low-bit rate. As one example, the NHV is configured to extract features representing a segment 114 of the audio data 112 and provide the features as input to a filter estimator. The filter estimator includes a neural network that is configured and trained to generate filter parameters for a noise filter (e.g., a first linear time varying (LTV) filter) and a harmonic filter (e.g., a second LTV filter). The noise filter is configured to modify a random noise signal based on the noise filter parameters from the filter estimator to generate data representing unvoiced speech components. The harmonic filter is configured to modify, based on the harmonic filter parameters from the filter estimator, an impulse train representing pitch of the audio segment to generate data representing voice speech components. The filter parameters (e.g., the noise filter parameters and the harmonic filter parameters), and possibly other data, are used to generate a representation of the segment. In other examples, the machine-learning audio encoder 144 can include a Low-Complexity Parametric Neural Network (LCPNet), a WaveNet coder, a Lyra coder, an EnCodec coder, or another machine-learning-based encoder that is particularly specialized for audio content of a target content type.

The waveform-matching audio encoder 146 is a procedural coder that attempts to represent a segment 114 of audio data 112 in a manner that enables reproduction of the entire waveform of the segment irrespective of the audio content represented by the waveform. For example, to limit computing resources used by the machine-learning audio encoder 144, the machine-learning audio encoder 144 is optimized (e.g., configured and trained) to encode audio data including a target type of audio content, such as speech, music, etc. at a low bit rate. In this example, the machine-learning audio encoder 144 may have difficulty encoding audio data that does not include the target type of audio content with the same degree of fidelity and at the same low bit rate. In contrast, the waveform-matching audio encoder 146 is a general-purpose coder that can encode any audio content with approximately the same degree of audio reproduction fidelity; however, to achieve this wide range of encoding, the waveform-matching audio encoder 146 has a higher bit rate than the machine-learning audio encoder 144 and may also use more computing resources to perform encoding. For example, the machine-learning audio encoder 144 is configured to encode an input segment 114 to generate an output 154 that includes a first number of bits to represent the segment 114, and the waveform-matching audio encoder 146 is configured to encode an input segment 114 to generate an output 156 that includes a second number of bits to represent the segment 114, where the first number is less than the second number.

The controller 142 is configured to cause a segment 114 of audio data 112 to be input to the machine-learning audio encoder 144, to the waveform-matching audio encoder 146, or to both, based on a classification associated with the segment 114. For example, the content-switchable coder system 140 includes an audio classifier 148 that is configured to generate an indicator 150 that indicates a classification associated with one of the segments 114, and the controller 142 selects one or more of the audio encoders 144, 146 to process the segment 114 based on the indicator 150. To illustrate, the audio classifier 148 may be configured to generate the indicator 150 to indicate whether the segment 114 represents audio content of a particular type (e.g., a target audio type of the machine-learning audio encoder 144). The target audio type can include, for example, speech, music, non-speech sounds, etc. The audio classifier 148 can include a machine-learning model (e.g., a classification model, such as a decision-tree, a neural network, a support vector machine, etc.). Alternatively, the audio classifier 148 can use a non-machine-learning technique, such as voice activity detection.

In some situations, switching between the machine-learning audio encoder 144 and the waveform-matching audio encoder 146 can introduce artifacts into the audio reproduced based on the output 154, 156 of the content-switchable coder system 140. For example, when the audio data 112 includes speech, some speech sounds may extend across more than one segment 114. In this example, switching encoders during such speech sounds can cause reproduced audio data 188 to include an artifact of the switching that reduces the intelligibility of the speech and/or leads to decreased user experience.

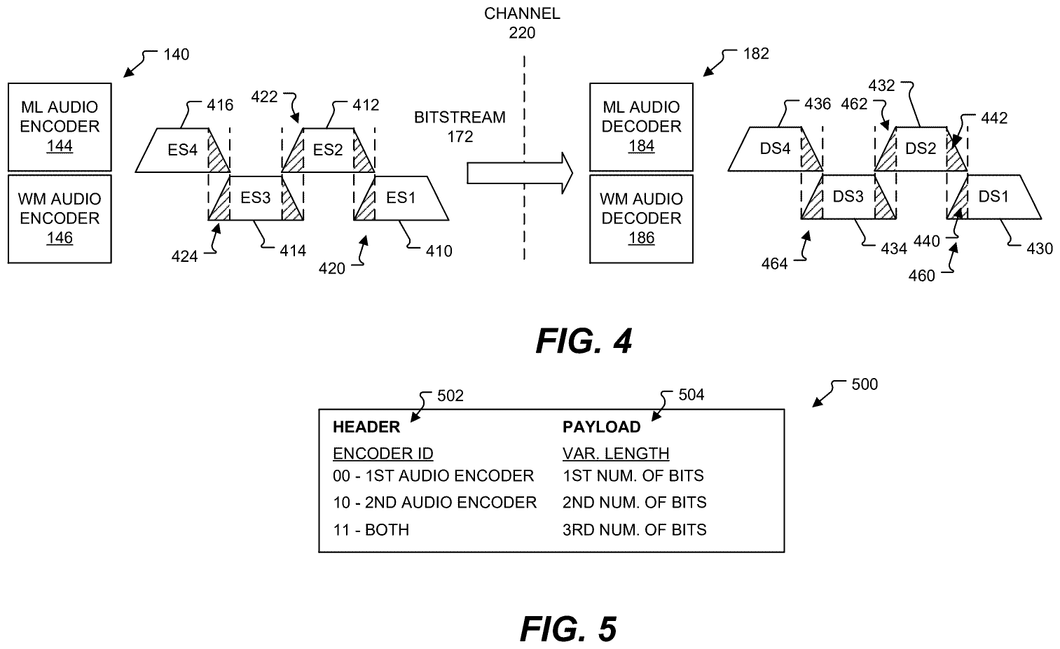

To limit the introduction of such artifacts, the controller 142 can optionally be configured to use one or more of various artifact mitigation techniques. One example of a technique to limit introduction of artifacts is to provide one or more segments 114 to both the machine-learning audio encoder 144 and the waveform-matching audio encoder 146. For example, in response to a determination to transition which audio encoder is provided segments 114 of the audio data 112, the controller 142 can provide at least one segment 114 of the audio data 112 to both the machine-learning audio encoder 144 and the waveform-matching audio encoder 146. In this example, the device 102, one or more remote devices 180, or both, can use blending techniques to combine a portion of the reproduced audio data 188 that is based on the output 154 of the machine-learning audio encoder 144 representing a segment 114 and a portion of the reproduced audio data 188 that is based on the output 156 of the waveform-matching audio encoder 146 representing the segment 114 to generate a blended version of the segment 114. FIGS. 3 and 4 illustrate examples of such blending.

Another example of a technique to limit introduction of artifacts is to use encoder state data 160 of a first audio encoder (e.g., the machine-learning audio encoder 144 or the waveform-matching audio encoder 146) to initialize the other audio encoder when switching from the first audio encoder to the other audio encoder. To illustrate, when different audio encoders are selected to process two sequential segments (e.g., the segment 114A and the segment 114B) of the audio data 112, encoder state data 160 resulting from processing the segment 114A (e.g., a first of the two sequential segments) is used to process the segment 114B (e.g., a second segment of the two sequential segments). For example, in some embodiments, artifacts can be reduced by populating excitation signal memories of the waveform-matching audio encoder 146 based on information from the machine-learning audio encoder 144. Such implementations may enable the waveform-matching audio encoder 146 to start generating a smoother evolution of the pitch pulse sequence, instead of starting from zeros or some other default encoder state data 160.

Another example of a technique to limit introduction of artifacts is to delay switching between audio encoders based on audio content of the segments. To illustrate, in some embodiments, the controller 142 is configured to use a first delay when transitioning to causing segments to be input to the waveform-matching audio encoder 146 and configured to use a second delay when transitioning to causing segments to be input to the machine-learning audio encoder 144. In such embodiments, the first delay is different from the second delay. For example, the first delay may be fixed, and the second delay may be variable and selected based on content of the segments 114. To illustrate, when the segment 114A includes speech (or other target audio data) and the segment 114B (e.g., a segment immediately following the segment 114A) includes non-speech (or other non-target audio data), the controller 142 sends the segment 114A to the machine-learning audio encoder 144 and sends the segment 114B to the waveform-matching audio encoder 146 (e.g., with a delay of zero segments). In this example, a delay of zero segments is used because encoding even just a few of some types of non-speech signals using the machine-learning audio encoder 144 can cause significant audio artifacts. In contrast, when switching in the other direction (e.g., from the waveform-matching audio encoder 146 to the machine-learning audio encoder 144), a delay based on content of the audio data 112 can be used to avoid switching artifacts. To illustrate, the controller 142 can delay switching to the machine-learning audio encoder 144 until the end of a speech sound (e.g., a vowel sound) is detected or until a low energy segment 114 (e.g., a segment representing silence) is detected. The waveform-matching audio encoder 146 may be able to encode both target and non-target audio equally well, but at the cost of using more computing and communication resources. Accordingly, delaying transition from the waveform-matching audio encoder 146 to the machine-learning audio encoder 144 is less efficient than switching immediately, but can avoid introduction of audio artifacts.

Various combinations of the above-described techniques can be used together. For example, in some embodiments, the controller 142 is configured to select a single one of the audio encoders to process each respective segment 114 of the audio data. In such embodiments, switching delays, using encoder state data from one encoder to initialize another encoder, or both, can be used to limit artifacts. In other embodiments, the controller 142 is configured to, at least under some circumstances, select two or more of the audio encoders to encode a particular segment 114 of the audio data 112. In some such embodiments, the controller 142 can also use the encoder state data 160 from one encoder to initialize another encoder to further limit artifacts.

In the example illustrated in FIG. 1, the device 102 includes a modem 170 coupled to the processor(s) 190 and configured to represent the output 154 of the machine-learning audio encoder 144, the output 156 of the waveform-matching audio encoder 146, or both, in a bitstream 172. For example, the bitstream 172 can be sent, via a communication channel, to the remote device(s) 180. In this example, the remote device(s) 180 include a decoder system 182 including decoders complementary to the audio encoders of the device 102. For example, the remote device(s) 180 include a machine-learning audio decoder 184 configured to process data representing the output 154 of the machine-learning audio encoder 144 to generate audio data representing a segment 114 input to the machine-learning audio encoder 144. Similarly, the remote device(s) 180 include a waveform-matching audio decoder 186 configured to process data representing the output 156 of the waveform-matching audio encoder 146 to generate audio data representing a segment 114 input to the waveform-matching audio encoder 146. In some implementations, the bitstream 172 includes information indicating which of the audio encoders of the device 102 was used to code each portion of the bitstream 130 to enable the remote device(s) 180 to select the corresponding audio decoder.

Although the content-switchable coder system 140 of FIG. 1 is illustrated as including two audio encoders 144, 146, in some embodiments, the content-switchable coder system 140 includes more than two audio encoders. In such embodiments, the controller 142 is configured to selectively send each of the segments 114 of the audio data 112 to any one or more of the audio encoders, depending on the content of each segment 114 and the particular artifact reduction technique(s) employed.

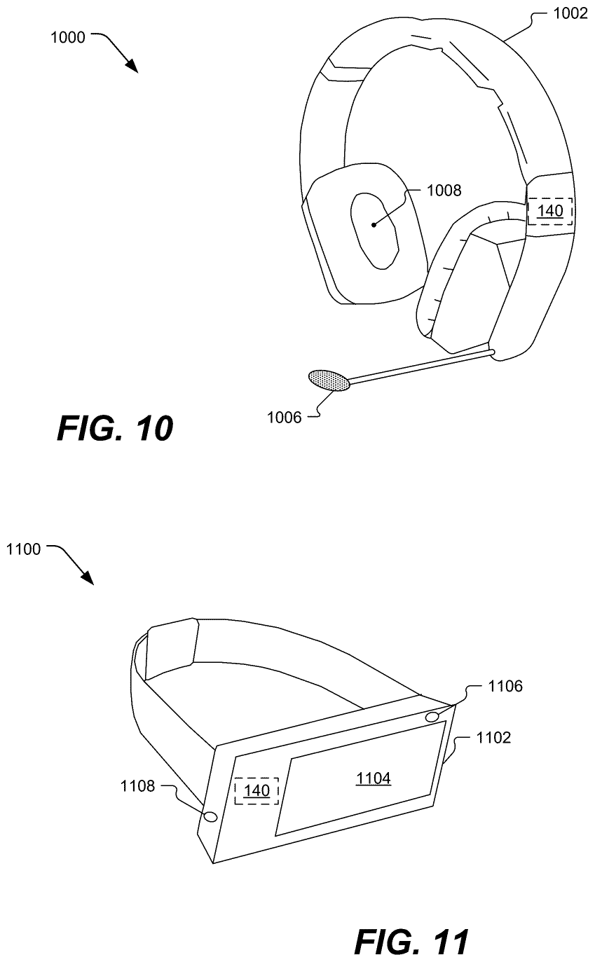

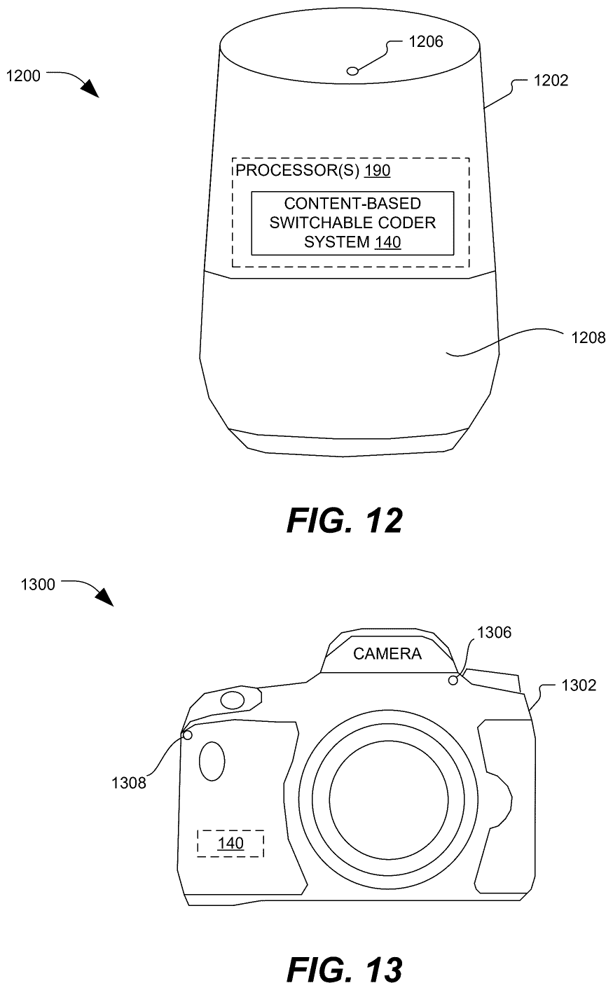

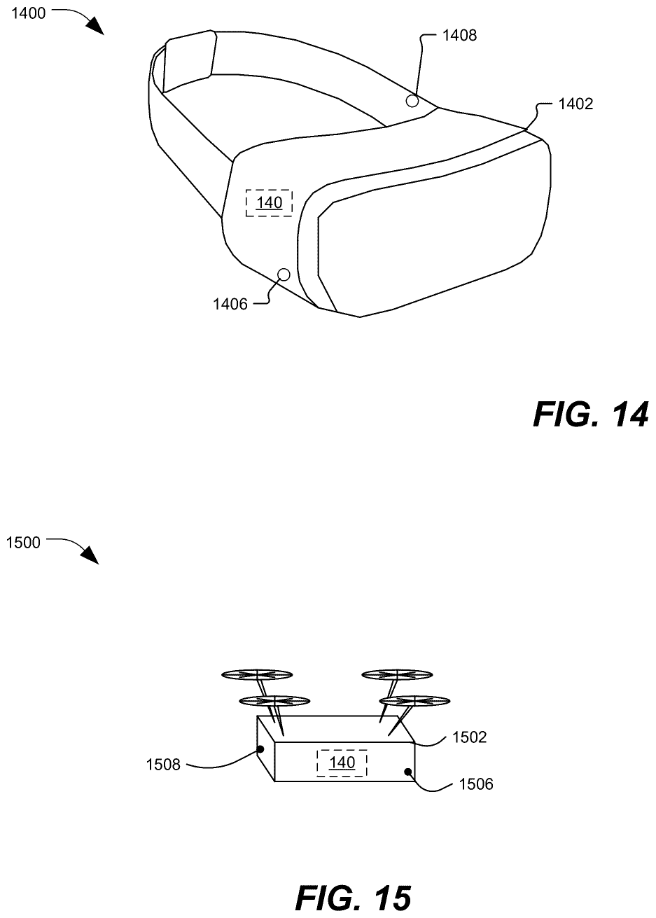

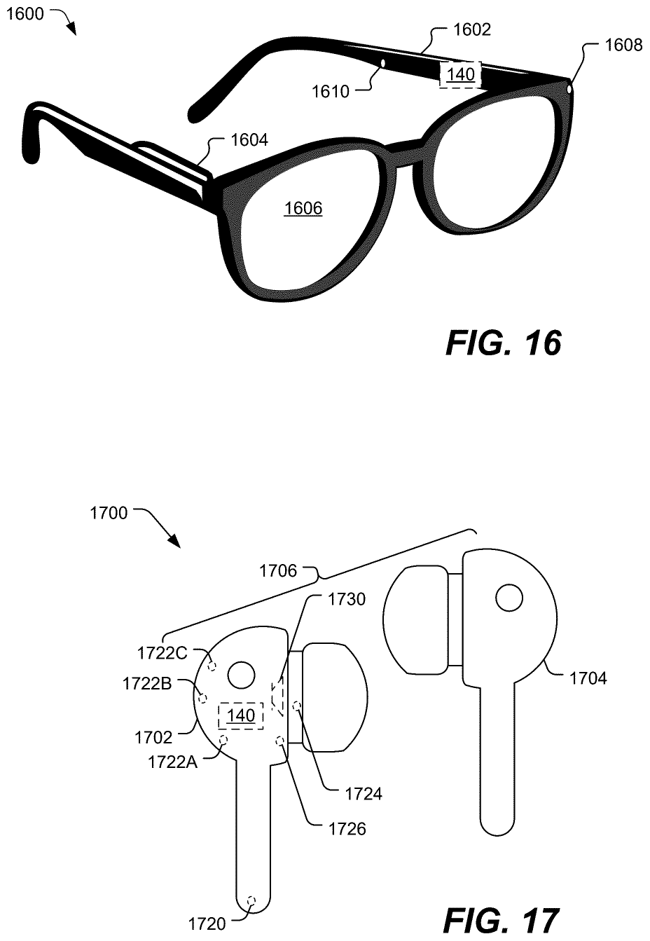

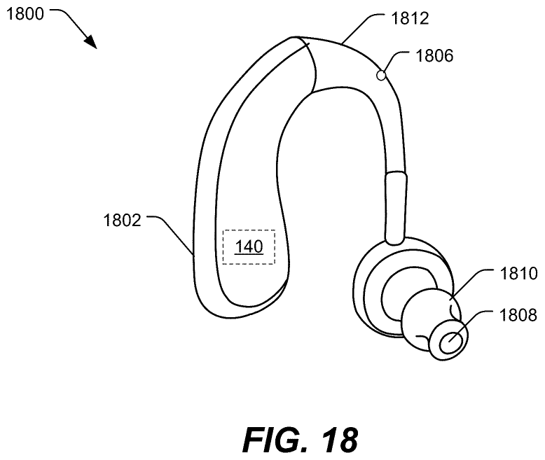

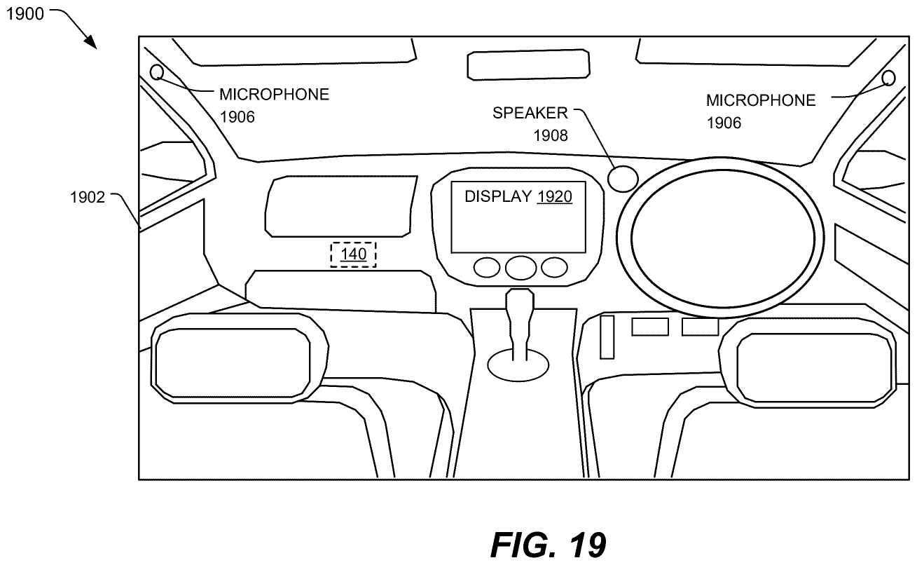

In some implementations, the device 102 corresponds to or is included in one of various types of devices. In an illustrative example, the processor 190 is integrated in a headset device, as described further with reference to FIG. 10. In other examples, the processor 190 is integrated in at least one of a mobile phone or a tablet computer device, as described with reference to FIG. 9, a wearable electronic device, as described with reference to FIG. 11, a voice-controlled speaker system, as described with reference to FIG. 12, a camera device, as described with reference to FIG. 13, or a virtual reality, mixed reality, or augmented reality headset, as described with reference to FIG. 14, a mixed reality or augmented reality glasses device, as described with reference to FIG. 16, earbuds, as described with reference to FIG. 17, or a hearing aid device, as described with reference to FIG. 18. In another illustrative example, the processor 190 is integrated into a vehicle, such as described further with reference to FIG. 15 and FIG. 19.

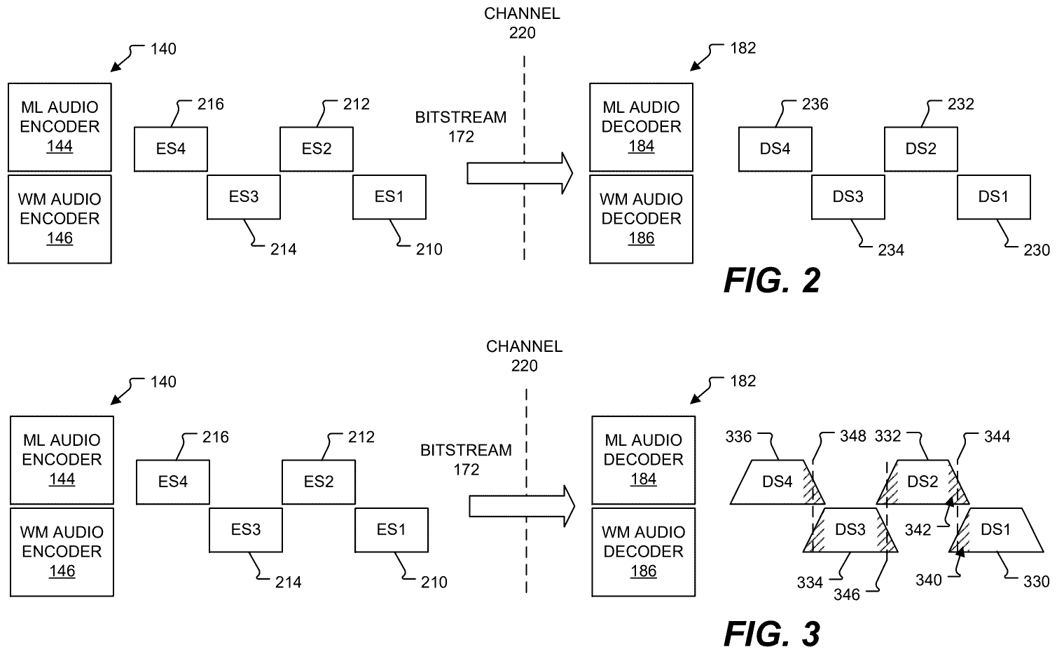

FIGS. 2-4 illustrate aspects of operation of a content-switchable codec. Each of FIGS. 2-4 includes the content-switchable coder system 140 of FIG. 1, including the machine-learning (ML) audio encoder 144 and the waveform-matching (WM) audio encoder 146. Additionally, each of FIGS. 2-4 includes the decoder system 182 of FIG. 1, including the machine-learning audio decoder 184 and the waveform-matching audio decoder 186.

In each of FIGS. 2-4, the decoder system 182 is configured to generate decoded segments (DS) based on data representing encoded segments (ES) from the content-switchable coder system 140. For example, in FIG. 2, the machine-learning audio decoder 184 is configured to generate decoded segment(s) 232 based on data representing encoded segment(s) 212 from the machine-learning audio encoder 144. Likewise, the waveform-matching audio decoder 186 is configured to generate decoded segment(s) 230 based on data representing encoded segment(s) 210 from the waveform-matching audio encoder 146. Each of FIGS. 2-4, illustrates encoded segments transmitted in the bitstream 172 over a channel 220 (such as in one or more wired or wireless transmissions); however, in other embodiments, the encoded segments can be stored in a memory and subsequently retrieved to undergo decoding.

FIG. 2 illustrates operation of a content-switchable codec in which the content-switchable coder system 140 is configured to provide each segment 114 to a single audio encoder. For example, based on the indication 150 from the audio classifier 148, the controller 142 of FIG. 1 causes a segment 114 of the audio data 112 to be sent to a single one of the machine-learning audio encoder 144 or the waveform-matching audio encoder 146. To illustrate, when the machine-learning audio encoder 144 is associated with a target content type, the indication 150 can indicate, for each of the segments 114, whether the segment 114 includes audio data representing the target content type. When the segment 114 includes audio data representing the target content type, the indicator 150 has a first value and when the segment includes audio data that does not represent the target content type, the indicator 150 has a second value.

In FIG. 2, the encoded segment(s) 210 include one or more segments 114 encoded by the waveform-matching audio encoder 146, the encoded segment(s) 212 include one or more segments 114 encoded by the machine-learning audio encoder 144, encoded segment(s) 214 include one or more segments 114 encoded by the waveform-matching audio encoder 146, and encoded segment(s) 216 include one or more segments 114 encoded by the machine-learning audio encoder 144. The encoded segments 210-216 represent a time-sequence in which the encoded segment(s) 210 precede the encoded segment(s) 212, the encoded segment(s) 212 precede the encoded segment(s) 214, and the encoded segment(s) 214 precede the encoded segment(s) 216. The encoded segment(s) 210-216 can each include data representing one, or more than one, of the segments 114 of FIG. 1. For example, the encoded segment(s) 210 can include data representing a single one of the segments 114 (such as segment 114A) or can include data representing more than one of the segments 114 (such as both the segment 114A and the segment 114B).

As described above, in some embodiments, the machine-learning audio encoder 144 is configured to encode a segment of audio data using a first number of bits, and the waveform-matching audio encoder 146 is configured to encode a segment of audio data using a second number of bits that is greater than the first number of bits. Thus, if the encoded segment 210 and the encoded segment 212 each represent the same number of segments, the encoded segment 210 includes more bits than the encoded segment 212.

Audio output based on the decoded segments 230-236 can include artifacts due to switching codecs between some segments. For example, switching from a machine-learning audio codec to the waveform-matching audio codec between decoded segment(s) 232 and decoded segment(s) 234 can introduce artifacts in the audio output. The content-switchable coder system 140 of FIG. 1 can use any of several techniques to limit introduction of such artifacts. For example, the content-switchable coder system 140 can delay switching from the waveform-matching audio encoder 146 to the machine-learning audio encoder 144 until the end of a vowel sound or until a low energy segment. To illustrate, the encoded segment(s) 210 can end with data representing the end of a vowel sound, and the encoded segment(s) 212 can begin with a next sound of the audio data 112 or silence.

As another example, when switching from the waveform-matching audio encoder 146 to the machine-learning audio encoder 144, coder state data of the machine-learning audio encoder 144 can be initialized based on information from the waveform-matching audio encoder 146, or vice versa. To illustrate, coder state data based on encoding of the encoded segment(s) 210 can be used to initialize the machine-learning audio encoder 144 when the machine-learning audio encoder 144 begins generation of the encoded segment(s) 212. Additionally, or alternatively, encoder state data based on encoding of the encoded segment(s) 212 can be used to initialize the waveform-matching audio encoder 146 when the waveform-matching audio encoder 146 begins generation of the encoded segment(s) 214.

The example illustrated in FIG. 3 is similar to the example illustrated in FIG. 2 except that in FIG. 3, the decoder system 182 performs blending operations to reduce artifacts due to switching audio codecs. In the example illustrated in FIG. 2, each segment is provided as input to one audio encoder 144 or 146 to generate an encoded segment 210-216, each encoded segment 210-216 is decoded by the corresponding audio decoder 184 or 186 to generate a decoded segment 230-236, and audio output is generated by playout of the decoded segments 230-236. Like FIG. 2, in FIG. 3 each segment is provided as input to one audio encoder 144 or 146 to generate an encoded segment 210-216, and each encoded segment 210-216 is decoded by the corresponding audio decoder 184 or 186 to generate a decoded segment 230-236. However, in contrast to FIG. 2, in FIG. 3 portions of the decoded segment(s) 330-336 on either side of a switching transition are blended to generate audio output. For example, a portion 340 of the decoded segment(s) 330 can be blended with a portion 342 of the decoded segment(s) 332. The portions 340, 342 can be estimated using an estimation process, such as an interpolation or extrapolation process used for frame erasure concealment. In this example, the audio output is based on the decoded segment(s) 330 well before a transition point 344; however, as the transition point 344 is approached, a weighted blending of audio data from the portion 340 and audio data of the portion 342 is performed, where the weighting gradually decreases the influence of the portion 340 and gradually increases the influence of the portion 342. Similar blending can be performed near other transition points, such as transition points 346 and 348. Blending audio content near the transition points 344-348 reduces artifacts due to switching audio codecs. In some embodiments, the blending illustrated in FIG. 3 can be performed in conjunction with other artifact reduction techniques, such as those described with reference to FIG. 2.

FIG. 4 illustrates operation of a content-switchable codec in which the content-switchable coder system 140 is configured to provide some segments 114 to more than one audio encoder to reduce artifacts due to transitioning between the audio encoders. For example, when transitioning between the audio encoders 144, 146, the controller 142 of the content-switchable coder system 140 causes at least one segment 114 of the audio data 112 to be sent to both the machine-learning audio encoder 144 and the waveform-matching audio encoder 146. As a result, the encoded segment(s) 410 and the encoded segment(s) 412 overlap in at least an overlap region 420. In some embodiments, the encoded segment(s) 410 and the encoded segment(s) 412 fully overlap (e.g., are encodings of the same audio data by different ones of the audio encoders 144, 146). Likewise, the encoded segment(s) 412 and the encoded segment(s) 414 overlap in at least an overlap region 422 and the encoded segment(s) 414 and the encoded segment(s) 416 overlap in at least an overlap region 424.

In FIG. 4, the decoder system 182 smooths content of the overlap regions 460-464 of adjacent decoded segments 430-436 to generate audio output. For example, a portion 440 of the decoded segment(s) 430 corresponding to the overlap region 460 can be smoothed with a portion 442 of the decoded segment(s) 432 corresponding to the overlap region 460. In this example, the audio output is based on the portions 440, 442 of the decoded segments 430 and 432 associated with the overlap region 460. To illustrate, to generate audio output associated with the overlap region 460 a weighted smoothing of audio data from the portion 440 and audio data of the portion 442 is performed, where the weighting gradually decreases the influence of the portion 440 and gradually increases the influence of the portion 442.

FIG. 5 is a table 500 illustrating an example of a packet structure that can be used by the device 102 of FIG. 1 to send data representing encoded segments 114 of the audio data 112. The table 500 includes a header column 502 representing information included in a packet header under various circumstances, and a payload column 504 indicating a payload size under the various circumstances.

In the example illustrated in FIG. 5, a two-bit encoder ID field of a header of a packet is used to identify which audio encoder was used to encode segments represented in the payload of the packet. For example, in FIG. 5, a value of 00 in the encoder ID field indicates that a first audio encoder, such as the machine-learning audio encoder 144 of FIG. 1, was used to encode the segments represented by data in the payload of the packet. As another example, a value of 10 in the encoder ID field indicates that a second audio encoder, such as the waveform-matching audio encoder 146 of FIG. 1, was used to encode the segments represented by data in the payload of the packet. As another example, a value of 11 in the encoder ID field indicates that both the first audio encoder and the second audio encoder were used to encode the segments represented by data in the payload of the packet. When both audio encoders are used to encode a segment in the payload of the packet, the decoder can determine the location of each encoded segment in the payload based on the number of bits used to encode each. For example, an encoded segment from the first audio encoder may include a first number of bits, and an encoded segment from the second audio encoder may include a second number of bits (as indicated in payload column 504). Thus, the decoder can detect that a bit following the first number of bits of a first encoded segment in the payload corresponds to a first bit of a second encoded segment.

The specific values listed in the table 500 are merely illustrative. In other embodiments, different values are used to indicate which audio encoder was used to encode the segments. Further, in some embodiments, the encoder ID field can include a different number of bits.

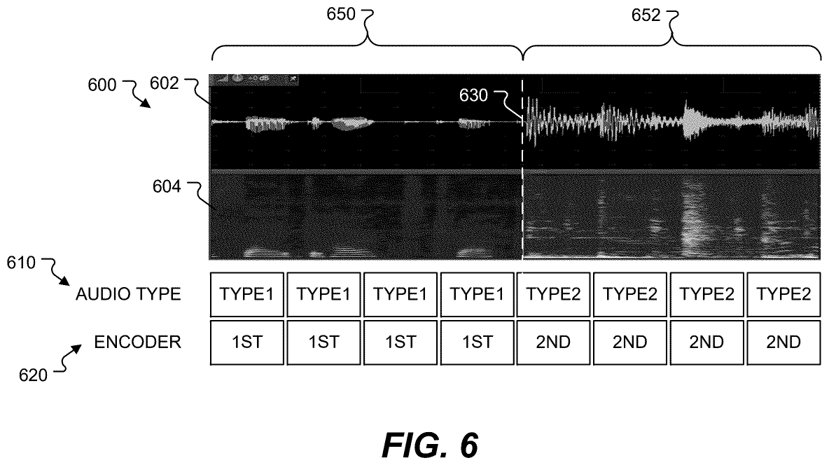

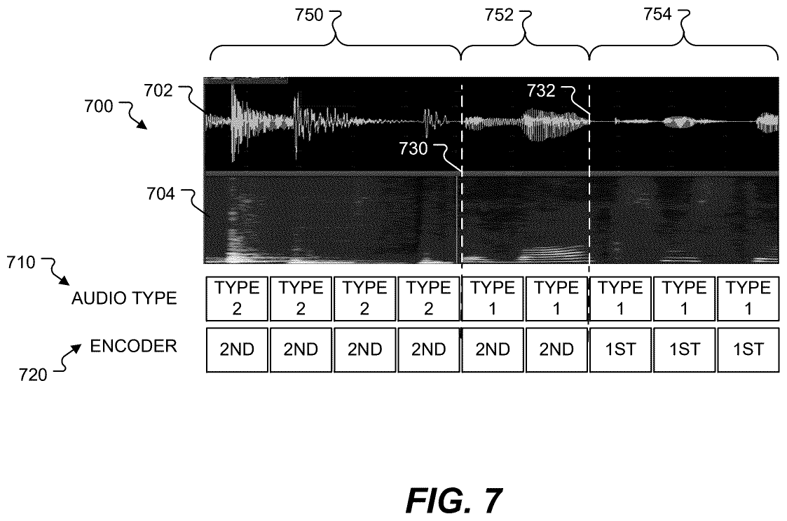

FIGS. 6 and 7 illustrate examples of switching schemes for transitioning between audio encoders. In particular, FIG. 6 illustrates an example of switching between two encoders with a fixed delay (e.g., a zero delay in FIG. 6). In contrast, FIG. 7 illustrates an example of switching between two encoders with a variable delay (e.g., a delay based on content of one or more segments in FIG. 7).

FIG. 6 includes a graph 600 showing amplitude 602 and frequency 604 of sound that is to be encoded by the content-switchable coder system 140 of FIG. 1. Below the graph 600, FIG. 6 illustrates information associated with various segments of audio data representing the sound. In FIG. 6, each segment is associated with an audio type 610 identifier and an encoder 620 identifier. The audio type 610 identifier of a segment indicates a classification associated with the segment. For example, in FIG. 6, “TYPE1” may indicate that the segment is associated with a target type of audio data (e.g., speech), and “TYPE2” may indicate that the segment is associated with a non-target type of audio data (e.g., non-speech).

In FIG. 6, during a first period 650, the sound includes TYPE1 content (e.g., speech) represented by four segments of the audio data. During a second period 652, the sound includes TYPE2 content (e.g., non-speech sounds) represented by four segments of the audio data. A transition between TYPE1 content and TYPE2 content occurs at a time 630. Since FIG. 6 illustrates an example in which a fixed, zero delay is used for transitioning between encoders, the first encoder is used for the four segments of TYPE1 content associated with the first period 650, and the second encoder is used for the four segments of TYPE2 content associated with the second period 652.

FIG. 7 includes a graph 700 showing amplitude 702 and frequency 704 of sound that is to be encoded by the content-switchable coder system 140 of FIG. 1. Below the graph 700, FIG. 7 illustrates information associated with various segments of audio data representing the sound. In FIG. 7, each segment is associated with an audio type 710 identifier and an encoder 720 identifier. The audio type 710 identifier of a segment indicates a classification associated with the segment. For example, in FIG. 7, “TYPE1” may indicate that the segment is associated with a target type of audio data (e.g., speech), and “TYPE2” may indicate that the segment is associated with a non-target type of audio data (e.g., non-speech).

In FIG. 7, during a first period 750, the sound includes TYPE2 content (e.g., non-speech sounds) represented by four segments of the audio data. During a second period 752, the sound includes TYPE1 content (e.g., speech) represented by two segments of the audio data. During a third period 754, the sound includes TYPE1 content (e.g., speech) represented by three segments of the audio data. Thus, a transition between TYPE2 content and TYPE1 content occurs at a time 730.

In FIG. 7, the transition from the second encoder to the first encoder occurs at a time 732. For example, during the period 752, the energy of the sound is relatively high (e.g., as compared to immediately following the time 732). During such high energy periods, the transition from the second encoder to the first encoder is more likely to introduce artifacts. Accordingly, the transition is delayed until a low energy period is detected.

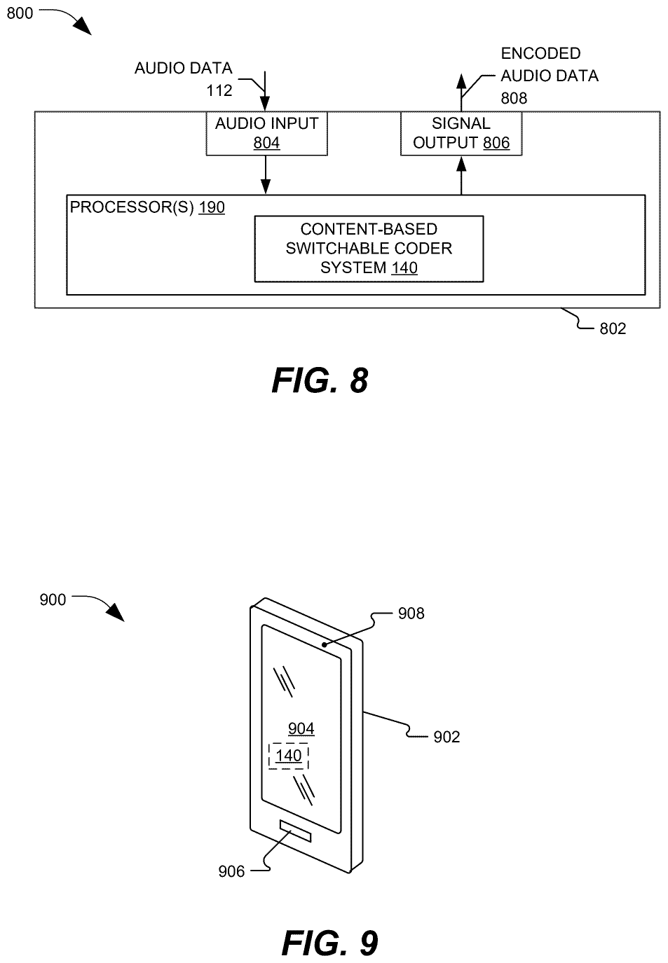

FIG. 8 depicts an implementation 800 of the device 102 as an integrated circuit 802 that includes the one or more processors 190. The integrated circuit 802 also includes an audio input 804, such as one or more bus interfaces, to enable the audio data 112 to be received for processing. The integrated circuit 802 also includes a signal output 806, such as a bus interface, to enable sending of an output signal, such as encoded audio data 808. In this example, the encoded audio data 808 can correspond to or include the output 154 of the machine-learning audio encoder 144 of FIG. 1, the output 156 of the waveform-matching audio encoder 146 of FIG. 1, the bitstream 172 of any of FIGS. 1-4, one or more packets including a header and a payload as in the table 500 of FIG. 5, etc. The integrated circuit 802 including the content-switchable coder system 140 enables implementation of content-switchable audio coding as a component in a system, such as a mobile phone or tablet as depicted in FIG. 9, a headset as depicted in FIG. 10, a wearable electronic device as depicted in FIG. 11, a voice-controlled speaker system as depicted in FIG. 12, a camera as depicted in FIG. 13, a virtual reality, mixed reality, or augmented reality headset as depicted in FIG. 14, a mixed reality or augmented reality glasses device, as described with reference to FIG. 16, earbuds, as described with reference to FIG. 17, a hearing aid device, as described with reference to FIG. 18 or a vehicle as depicted in FIG. 15 or FIG. 19.

FIG. 9 depicts an implementation 900 in which the device 102 includes a mobile device 902, such as a phone or tablet, as illustrative, non-limiting examples. The mobile device 902 includes one or more microphones 906, one or more speakers 908, and a display screen 904. Components of the processor 190, including the content-switchable coder system 140, are integrated in the mobile device 902 and are illustrated using dashed lines to indicate internal components that are not generally visible to a user of the mobile device 902. In a particular example, the content-switchable coder system 140 is operable to obtain audio data representing sound captured by the microphone(s) 906, determine a type of audio content associated with a segment of the audio data, and encode the segment using a machine-learning audio encoder, a waveform-matching audio encoder, or both, based on the type of audio content associated with the segment. Selectively encoding segments of audio data using the machine-learning audio encoder, the waveform-matching audio encoder, or both, enables the mobile device 902 to efficiently (in terms of computing resources and power) generate a representation of the audio data that is suitable for high quality sound reproduction.

FIG. 10 depicts an implementation 1000 in which the device 102 includes a headset device 1002. The headset device 1002 includes one or more microphones 1006 and one or more speakers 1008. Components of the processor 190, including the content-switchable coder system 140, are integrated in the headset device 1002. In a particular example, the content-switchable coder system 140 is operable to obtain audio data representing sound captured by the microphone(s) 1006, determine a type of audio content associated with a segment of the audio data, and encode the segment using a machine-learning audio encoder, a waveform-matching audio encoder, or both, based on the type of audio content associated with the segment. Selectively encoding segments of audio data using the machine-learning audio encoder, the waveform-matching audio encoder, or both, enables the headset device 1002 to efficiently (in terms of computing resources and power) generate a representation of the audio data that is suitable for high quality sound reproduction.

FIG. 11 depicts an implementation 1100 in which the device 102 includes a wearable electronic device 1102, illustrated as a “smart watch.” The wearable electronic device 1102 includes a display screen 1104, one or more microphones 1106, and one or more speakers 1108. Components of the processor 190, including the content-switchable coder system 140, are integrated in the wearable electronic device 1102. In a particular example, the content-switchable coder system 140 is operable to obtain audio data representing sound captured by the microphone(s) 1106, determine a type of audio content associated with a segment of the audio data, and encode the segment using a machine-learning audio encoder, a waveform-matching audio encoder, or both, based on the type of audio content associated with the segment. Selectively encoding segments of audio data using the machine-learning audio encoder, the waveform-matching audio encoder, or both, enables the wearable electronic device 1102 to efficiently (in terms of computing resources and power) generate a representation of the audio data that is suitable for high quality sound reproduction. In some embodiments, the wearable electronic device 1102 is configured to generate a notification based on content of one or more of the segments. For example, the display screen 1104 can generate visual information based on the content of the segment(s). As another example, the wearable electronic device 1102 can include a haptic device that provides a haptic notification (e.g., vibrates) based on content of the segment(s).

FIG. 12 is an implementation 1200 in which the device 102 includes a wireless speaker and voice activated device 1202. The wireless speaker and voice activated device 1202 can have wireless network connectivity and is configured to execute an assistant operation. The wireless speaker and voice activated device 1202 includes one or more microphones 1206 and one or more speakers 1208. Components of the processor 190, including the content-switchable coder system 140, are integrated in the wireless speaker and voice activated device 1202. In a particular example, the content-switchable coder system 140 is operable to obtain audio data representing sound captured by the microphone(s) 1206, determine a type of audio content associated with a segment of the audio data, and encode the segment using a machine-learning audio encoder, a waveform-matching audio encoder, or both, based on the type of audio content associated with the segment. Selectively encoding segments of audio data using the machine-learning audio encoder, the waveform-matching audio encoder, or both, enables the wireless speaker and voice activated device 1202 to efficiently (in terms of computing resources and power) generate a representation of the audio data that is suitable for high quality sound reproduction.

FIG. 13 depicts an implementation 1300 in which the device 132 includes a portable electronic device that corresponds to a camera device 1302. The camera device 1302 includes one or more microphones 1306 and one or more speakers 1308. Components of the processor 190, including the content-switchable coder system 140, are integrated in the camera device 1302. In a particular example, the content-switchable coder system 140 is operable to obtain audio data representing sound captured by the microphone(s) 1306, determine a type of audio content associated with a segment of the audio data, and encode the segment using a machine-learning audio encoder, a waveform-matching audio encoder, or both, based on the type of audio content associated with the segment. Selectively encoding segments of audio data using the machine-learning audio encoder, the waveform-matching audio encoder, or both, enables the camera device 1302 to efficiently (in terms of computing resources and power) generate a representation of the audio data that is suitable for high quality sound reproduction.

FIG. 14 depicts an implementation 1400 in which the device 102 includes a portable electronic device that corresponds to a virtual reality, mixed reality, or augmented reality headset 1402. A visual interface device is positioned in front of the user's eyes to enable display of augmented reality, mixed reality, or virtual reality images or scenes to the user while the headset 1402 is worn. The headset 1402 also includes one or more microphones 1406 and one or more speakers 1408. Components of the processor 190, including the content-switchable coder system 140, are integrated in the headset 1402. In a particular example, the content-switchable coder system 140 is operable to obtain audio data representing sound captured by the microphone(s) 1406, determine a type of audio content associated with a segment of the audio data, and encode the segment using a machine-learning audio encoder, a waveform-matching audio encoder, or both, based on the type of audio content associated with the segment. Selectively encoding segments of audio data using the machine-learning audio encoder, the waveform-matching audio encoder, or both, enables the headset 1402 to efficiently (in terms of computing resources and power) generate a representation of the audio data that is suitable for high quality sound reproduction.

FIG. 15 depicts an implementation 1500 in which the device 102 corresponds to, or is integrated within, a vehicle 1502, illustrated as a manned or unmanned aerial device (e.g., a package delivery drone). The vehicle 1502 includes one or more microphones 1506, and one or more speakers 1508. Components of the processor 190, including the content-switchable coder system 140, are integrated in the vehicle 1502. In a particular example, the content-switchable coder system 140 is operable to obtain audio data representing sound captured by the microphone(s) 1506, determine a type of audio content associated with a segment of the audio data, and encode the segment using a machine-learning audio encoder, a waveform-matching audio encoder, or both, based on the type of audio content associated with the segment. Selectively encoding segments of audio data using the machine-learning audio encoder, the waveform-matching audio encoder, or both, enables the vehicle 1502 to efficiently (in terms of computing resources and power) generate a representation of the audio data that is suitable for high quality sound reproduction. For example, a spoken instruction can be captured by the microphone(s) 1506 and transmitted as a bitstream (e.g., bitstream 172 of FIG. 1) to a remote device for processing (e.g., to detect delivery instructions or to determine whether the spoken instructions were from an authorized user).

FIG. 16 depicts an implementation 1600 in which the device 102 includes a portable electronic device that corresponds to augmented reality or mixed reality glasses 1602. The glasses 1602 include a holographic projection unit 1604 configured to project visual data onto a surface of a lens 1606 or to reflect the visual data off of a surface of the lens 1606 and onto the wearer's retina. The glasses 1602 also include one or more microphones 1608 and one or more speakers 1610. Components of the processor 190, including the content-switchable coder system 140, are integrated in the glasses 1602. In a particular example, the content-switchable coder system 140 is operable to obtain audio data representing sound captured by the microphone(s) 1608, determine a type of audio content associated with a segment of the audio data, and encode the segment using a machine-learning audio encoder, a waveform-matching audio encoder, or both, based on the type of audio content associated with the segment. Selectively encoding segments of audio data using the machine-learning audio encoder, the waveform-matching audio encoder, or both, enables the glasses 1602 to efficiently (in terms of computing resources and power) generate a representation of the audio data that is suitable for high quality sound reproduction. In a particular example, the holographic projection unit 1604 is configured to display a notification indicating a detected audio event. For example, the notification may be based on content of one or more of the segments.

FIG. 17 depicts an implementation 1700 in which the device 102 includes a portable electronic device that corresponds to a pair of earbuds 1706 that includes a first earbud 1702 and a second earbud 1704. Although earbuds are described, it should be understood that the present technology can be applied to other in-ear or over-ear audio devices.

The first earbud 1702 includes a first microphone 1720, such as a high signal-to-noise microphone positioned to capture the voice of a wearer of the first earbud 1702, an array of one or more other microphones configured to detect ambient sounds and spatially distributed to support beamforming, illustrated as microphones 1722A, 1722B, and 1722C, an “inner” microphone 1724 proximate to the wearer's ear canal (e.g., to assist with active noise cancelling), and a self-speech microphone 1726, such as a bone conduction microphone configured to convert sound vibrations of the wearer's ear bone or skull into an audio signal.

The second earbud 1704 can be configured in a substantially similar manner as the first earbud 1702. In some implementations, the first earbud 1702 is also configured to receive one or more audio signals generated by one or more microphones of the second earbud 1704, such as via wireless transmission between the earbuds 1702, 1704, or via wired transmission in implementations in which the earbuds 1702, 1704 are coupled via a transmission line.

In some implementations, the earbuds 1702, 1704 are configured to automatically switch between various operating modes, such as a passthrough mode in which ambient sound is played via a speaker 1730, a playback mode in which non-ambient sound (e.g., streaming audio corresponding to a phone conversation, media playback, video game, etc.) is played back through the speaker 1730, and an audio zoom mode or beamforming mode in which one or more ambient sounds are emphasized and/or other ambient sounds are suppressed for playback at the speaker 1730. In other implementations, the earbuds 1702, 1704 may support fewer modes or may support one or more other modes in place of, or in addition to, the described modes.

In an illustrative example, the earbuds 1702, 1704 can automatically transition from the playback mode to the passthrough mode in response to detecting the wearer's voice and may automatically transition back to the playback mode after the wearer has ceased speaking. In some examples, the earbuds 1702, 1704 can operate in two or more of the modes concurrently, such as by performing audio zoom on a particular ambient sound (e.g., a dog barking) and playing out the audio zoomed sound superimposed on the sound being played out while the wearer is listening to music (which can be reduced in volume while the audio zoomed sound is being played). In this example, the wearer can be alerted to the ambient sound associated with the audio event without halting playback of the music.

In FIG. 17, components of the processor 190, including the content-switchable coder system 140, are integrated in the earbuds 1702, 1704. In a particular example, the content-switchable coder system 140 is operable to obtain audio data representing sound captured by one or more of the microphone(s) 1720, 1722, 1724, 1726, determine a type of audio content associated with a segment of the audio data, and encode the segment using a machine-learning audio encoder, a waveform-matching audio encoder, or both, based on the type of audio content associated with the segment. Selectively encoding segments of audio data using the machine-learning audio encoder, the waveform-matching audio encoder, or both, enables the earbuds 1702, 1704 to efficiently (in terms of computing resources and power) generate a representation of the audio data that is suitable for high quality sound reproduction.

FIG. 18 illustrates a hearing aid device 1800 that incorporates aspects of the device 102 of FIG. 1. In FIG. 18, the hearing aid device 1800 includes a housing 1802 including an over-ear portion 1812 configured to be worn over the ear of a user. An earpiece 1810 is coupled to the housing 1802 and includes one or more speakers 1808. In some embodiments, one or more microphones 1806 are disposed on the housing 1802.

In FIG. 18, components of the processor 190, including the content-switchable coder system 140, are integrated in the hearing aid device 1800. In a particular example, the content-switchable coder system 140 is operable to obtain audio data representing sound captured by the microphone(s) 1806, determine a type of audio content associated with a segment of the audio data, and encode the segment using a machine-learning audio encoder, a waveform-matching audio encoder, or both, based on the type of audio content associated with the segment. Selectively encoding segments of audio data using the machine-learning audio encoder, the waveform-matching audio encoder, or both, enables the hearing aid device 1800 to efficiently (in terms of computing resources and power) generate a representation of the audio data that is suitable for high quality sound reproduction.

FIG. 19 depicts another implementation 1900 in which the device 102 corresponds to, or is integrated within, a vehicle 1902, illustrated as a car. The vehicle 1902 includes a display screen 1920, one or more microphones 1906, and one or more speakers 1908. Components of the processor 190, including the content-switchable coder system 140, are integrated in the vehicle 1902. In a particular example, the content-switchable coder system 140 is operable to obtain audio data representing sound captured by the microphone(s) 1906, determine a type of audio content associated with a segment of the audio data, and encode the segment using a machine-learning audio encoder, a waveform-matching audio encoder, or both, based on the type of audio content associated with the segment. Selectively encoding segments of audio data using the machine-learning audio encoder, the waveform-matching audio encoder, or both, enables the vehicle 1902 to efficiently (in terms of computing resources and power) generate a representation of the audio data that is suitable for high quality sound reproduction.

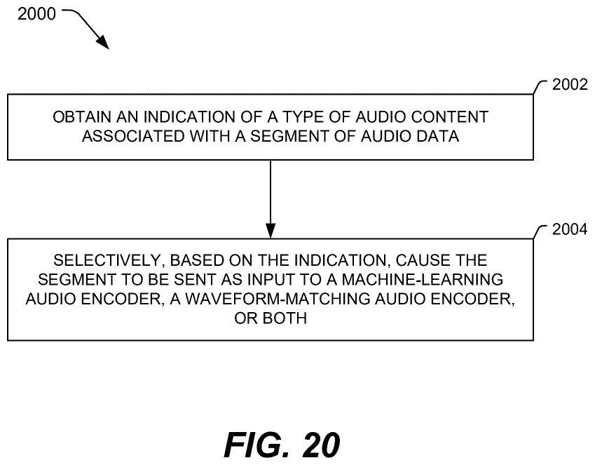

Referring to FIG. 20, a particular implementation of a method 2000 of switching audio codecs based on content of one or more segments of audio data is shown. In a particular aspect, one or more operations of the method 2000 are performed by at least one of the content-switchable coder system 140, the processor 190, the device 102, the system 100 of FIG. 1, or a combination thereof.

In some embodiments, the method 2000 includes, at block 2002, obtaining, by one or more processors, an indication of a type of audio content associated with a segment of audio data. For example, the controller 142 of FIG. 1 can receive an indication (e.g., the indicator 150) from the audio classifier 148. The indication may indicate a classification associated with the segment of audio data. The audio classifier 148 can include a machine-learning based classifier, a procedural classifier (e.g., a voice activity detector), or a combination thereof. The audio classifier 148 may generate the indication based on whether the segment represents audio content of a particular type, such as speech, music, wind noise, etc.

The method 2000 also includes, at block 2004, selectively, based on the indication, causing the segment to be sent as input to a machine-learning audio encoder, a waveform-matching audio encoder, or both. For example, the controller 142 of FIG. 1 may cause the segment 114 to be sent to the machine-learning audio encoder 144, to the waveform-matching audio encoder 146, or to both. In some embodiments, the controller is configured to cause each segment of the audio data to be sent as input to a single audio encoder. For example, each segment of the audio data is sent to either the machine-learning audio encoder or to the waveform-matching audio encoder. In other embodiments, the controller is configured to cause at least some segments of the audio data to be sent to both the machine-learning audio encoder and the waveform-matching audio encoder. For example, the controller may provide at least one segment of the audio data to both the machine-learning audio encoder and the waveform-matching audio encoder based on a determination to transition which audio encoder is provided segments of the audio data.

In some embodiments, the method 2000 includes generating a bitstream representing an output of the machine-learning audio encoder, an output of the waveform-matching audio encoder, or both. For example, the modem 170 of FIG. 1 can generate the bitstream 172, which may include the output 154, the output 156, or both, representing a particular input segment 114 of the audio data 112. In some embodiments, the machine-learning audio encoder and the waveform-matching audio encoder have different bit rates. For example, the machine-learning audio encoder may be configured to encode an input segment using a first number of bits, and the waveform-matching audio encoder may be configured to encode an input segment using a second number of bits, where the first number is less than the second number.

In some embodiments, the method 2000 includes, when a particular audio encoder is selected to process two sequential segments of the audio data, processing a second segment of the two sequential segments using encoder state data resulting from processing a first segment of the two sequential segments, where the second segment is subsequent to the first segment. For example, when the waveform-matching audio encoder 146 of FIG. 1 is selected to process the segment 114A and the segment 114B, which immediately follows the segment 114A, the encoder state data associated with processing of the segment 114A can be used to process the segment 114B. As another example, when the machine-learning audio encoder 144 of FIG. 1 is selected to process the segment 114A and the segment 114B, which immediately follows the segment 114A, the encoder state data associated with processing of the segment 114A can be used to process the segment 114B.

In some embodiments, the method 2000 includes, when different audio encoders are selected to process two sequential segments of the audio data, processing a second segment of the two sequential segments using encoder state data that is independent of processing a first segment of the two sequential segments, where the second segment is subsequent to the first segment. For example, when the waveform-matching audio encoder 146 of FIG. 1 is selected to process the segment 114A and the machine-learning audio encoder 144 is selected to process the segment 114B, which immediately follows the segment 114A, the encoder state data associated with processing of the segment 114A is not used to process the segment 114B. To illustrate, the encoder state data used to process the segment 114B can include or correspond to default state data or state data representing a state of the machine-learning audio encoder 144 prior to the waveform-matching audio encoder 146 encoding the segment 114A. As another example, when the machine-learning audio encoder 144 of FIG. 1 is selected to process the segment 114A and the waveform-matching audio encoder 146 is selected to process the segment 114B, which immediately follows the segment 114A, the encoder state data associated with processing of the segment 114A is not used to process the segment 114B. To illustrate, the encoder state data used to process the segment 114B can include or correspond to default state data or state data representing a state of the waveform-matching audio encoder 146 prior to the machine-learning audio encoder 144 encoding the segment 114A.

In some embodiments, the method 2000 includes, when different audio encoders are selected to process two sequential segments of the audio data, processing a second segment of the two sequential segments using encoder state data resulting from processing a first segment of the two sequential segments, where the second segment is subsequent to the first segment. For example, when the waveform-matching audio encoder 146 of FIG. 1 is selected to process the segment 114A and the machine-learning audio encoder 144 is selected to process the segment 114B, which immediately follows the segment 114A, the encoder state data associated with processing of the segment 114A can be provided to the machine-learning based audio encoder to initialize processing of the segment 114B. As another example, when the machine-learning audio encoder 144 of FIG. 1 is selected to process the segment 114A and the waveform-matching audio encoder 146 is selected to process the segment 114B, which immediately follows the segment 114A, the encoder state data associated with processing of the segment 114A can be provided to the waveform-matching audio encoder to initialize processing of the segment 114B.

In some embodiments, the method 2000 includes applying a first delay when transitioning to causing segments to be input to the waveform-matching audio encoder and applying a second delay when transitioning to causing segments to be input to the machine-learning audio encoder, wherein the first delay is different from the second delay. In some such embodiments, the first delay is fixed and the method 2000 further includes determining the second delay based on content of one or more of the segments.

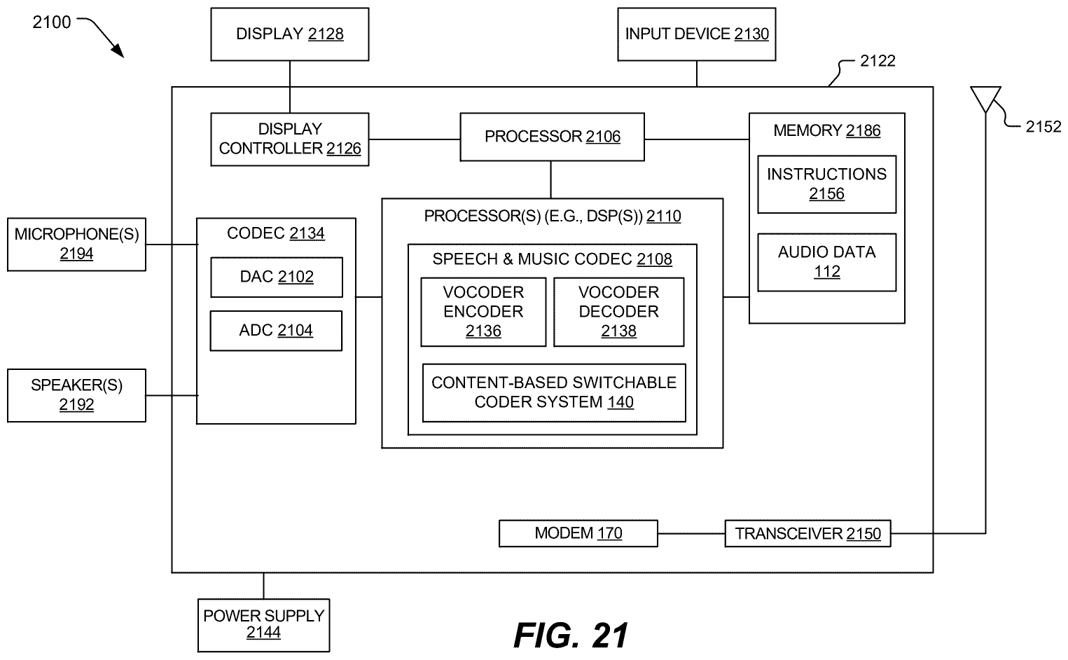

The method 2000 of FIG. 20 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 2000 of FIG. 20 may be performed by a processor that executes instructions, such as described with reference to FIG. 21.

Referring to FIG. 21, a block diagram of a particular illustrative implementation of a device is depicted and generally designated 2100. In various implementations, the device 2100 may have more or fewer components than illustrated in FIG. 21. In an illustrative implementation, the device 2100 may correspond to the device 102. In an illustrative implementation, the device 2100 may perform one or more operations described with reference to FIGS. 1-20.

In a particular implementation, the device 2100 includes a processor 2106 (e.g., a central processing unit (CPU)). The device 2100 may include one or more additional processors 2110 (e.g., one or more DSPs). In a particular aspect, the processor 190 of FIG. 1 corresponds to the processor 2106, the processors 2110, or a combination thereof. The processors 2110 may include a speech and music coder-decoder (CODEC) 2108 that includes a voice coder (“vocoder”) encoder 2136, a vocoder decoder 2138, the content-switchable coder system 140, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 2100 may include a memory 2186 and a CODEC 2134. The memory 2186 may include instructions 2156, that are executable by the one or more additional processors 2110 (or the processor 2106) to implement the functionality described with reference to the content-switchable coder system 140, or both. The device 2100 may include the modem 170 coupled, via a transceiver 2150, to an antenna 2152.

The device 2100 may include a display 2128 coupled to a display controller 2126. One or more speakers 2192, the microphone(s) 2194 may be coupled to the CODEC 2134. The CODEC 2134 may include a digital-to-analog converter (DAC) 2102, an analog-to-digital converter (ADC) 2104, or both. In a particular implementation, the CODEC 2134 may receive analog signals from the microphone(s) 2194, convert the analog signals to digital signals using the analog-to-digital converter 2104, and provide the digital signals to the speech and music codec 2108. The speech and music codec 2108 may process the digital signals, and the digital signals may further be processed by the content-switchable coder system 140. In a particular implementation, the speech and music codec 2108 may provide digital signals to the CODEC 2134. The CODEC 2134 may convert the digital signals to analog signals using the digital-to-analog converter 2102 and may provide the analog signals to the speaker 2192.

In a particular implementation, the device 2100 may be included in a system-in-package or system-on-chip device 2122. In a particular implementation, the memory 2186, the processor 2106, the processors 2110, the display controller 2126, the CODEC 2134, and the modem 170 are included in the system-in-package or system-on-chip device 2122. In a particular implementation, an input device 2130 and a power supply 2144 are coupled to the system-in-package or the system-on-chip device 2122. Moreover, in a particular implementation, as illustrated in FIG. 21, the display 2128, the input device 2130, the speaker(s) 2192, the microphone(s) 2194, the antenna 2152, and the power supply 2144 are external to the system-in-package or the system-on-chip device 2122. In a particular implementation, each of the display 2128, the input device 2130, the speaker(s) 2192, the microphone(s) 2194, the antenna 2152, and the power supply 2144 may be coupled to a component of the system-in-package or the system-on-chip device 2122, such as an interface or a controller.

The device 2100 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining an indication of a type of audio content associated with a segment of audio data. For example, the means for obtaining the indication of the type of audio content associated with the segment of audio data can include the system 100, the device 102, the processor(s) 190, the content-switchable coder system 140, controller 142, the audio classifier 148, the integrated circuit 802, the processor 2106, the processor(s) 2110, the system-in-package or the system-on-chip device 2122, the device 2100, other circuitry configured to obtain an indication of a type of audio content associated with a segment of audio data, or a combination thereof.

The apparatus also includes means for selectively, based on the indication, causing the segment to be sent as input to a machine-learning audio encoder, a waveform-matching audio encoder, or both. For example, the means for selectively causing the segment to be sent as input to a machine-learning audio encoder, a waveform-matching audio encoder, or both, based on the indication can include the system 100, the device 102, the processor(s) 190, the content-switchable coder system 140, controller 142, the integrated circuit 802, the processor 2106, the processor(s) 2110, the system-in-package or the system-on-chip device 2122, the device 2100, other circuitry configured to cause a segment to be selectively sent as input to a machine-learning audio encoder, a waveform-matching audio encoder, or both, based on an indication of a type of audio content associated with a segment of audio data, or a combination thereof.

In some implementations, a non-transitory computer-readable medium (e.g., a computer-readable storage device, such as the memory 2186) includes instructions (e.g., the instructions 2156) that, when executed by one or more processors (e.g., the one or more processors 2110 or the processor 2106), cause the one or more processors to obtain an indication of a type of audio content associated with a segment of audio data. The instructions also cause the one or more processors to selectively, based on the indication, cause the segment to be sent as input to a machine-learning audio encoder, a waveform-matching audio encoder, or both.

Particular aspects of the disclosure are described below in sets of interrelated Examples:

According to Example 1, a device includes a machine-learning audio encoder; a waveform-matching audio encoder; and a controller configured to cause a segment of audio data to be input to the machine-learning audio encoder, to the waveform-matching audio encoder, or to both, based on a classification associated with the segment.

Example 2 includes the device of Example 1, further comprising an audio classifier configured to generate an indicator of the classification based on whether the segment represents audio content of a particular type and configured to provide the indicator to the controller.

Example 3 includes the device of Example 1 or Example 2, further comprising a modem coupled to the machine-learning audio encoder and the waveform-matching audio encoder and configured to represent, in a bitstream, an output of the machine-learning audio encoder, an output of the waveform-matching audio encoder, or both.

Example 4 includes the device of any of Examples 1 to 3, wherein the machine-learning audio encoder is configured to encode an input segment using a first number of bits, wherein the waveform-matching audio encoder is configured to encode an input segment using a second number of bits, and wherein the first number is less than the second number.

Example 5 includes the device of any of Examples 1 to 4, wherein the controller is configured to select the machine-learning audio encoder to process a first set of segments that represent speech and to select the waveform-matching audio encoder to process a second set of segments that represent non-speech sounds.

Example 6 includes the device of any of Examples 1 to 5, wherein the controller is configured to select a single audio encoder to process each respective segment of the audio data.

Example 7 includes the device of any of Examples 1 to 5, wherein the controller is configured to, in response to a determination to transition which audio encoder is provided segments of the audio data, provide at least one segment of the audio data to both the machine-learning audio encoder and the waveform-matching audio encoder.

Example 8 includes the device of any of Examples 1 to 7 and further includes a modem coupled to the machine-learning audio encoder and the waveform-matching audio encoder and configured to represent, in a bitstream, an output of the machine-learning audio encoder, an output of the waveform-matching audio encoder, or both.

Example 9 includes the device of any of Examples 1 to 8, wherein, when a particular audio encoder is selected to process two sequential segments of the audio data, encoder state data resulting from processing a first segment of the two sequential segments is used to process a second segment of the two sequential segments, where the second segment is subsequent to the first segment.

Example 10 includes the device of any of Examples 1 to 9, wherein, when different audio encoders are selected to process two sequential segments of the audio data, default encoder state data is used to process a second segment of the two sequential segments, where the second segment is subsequent to the first segment.

Example 11 includes the device of any of Examples 1 to 9, wherein, when different audio encoders are selected to process two sequential segments of the audio data, encoder state data used by a second audio encoder to process a second segment of the two sequential segments is based on a prior state of the second audio encoder, where the second segment is subsequent to the first segment.

Example 12 includes the device of any of Examples 1 to 9, wherein, when different audio encoders are selected to process two sequential segments of the audio data, encoder state data used to process a second segment of the two sequential segments is based on processing of a first segment of the two sequential segments, where the second segment is subsequent to the first segment.

Example 13 includes the device of any of Examples 1 to 12, wherein the controller is configured to use a first delay when transitioning to causing segments to be input to the waveform-matching audio encoder and is configured to use a second delay when transitioning to causing segments to be input to the machine-learning audio encoder, wherein the first delay is different from the second delay.

Example 14 includes the device of Example 13, wherein the first delay is fixed and the second delay is variable and is selected based on content of the segments.

Example 15 includes the device of any of Examples 1 to 14, wherein the controller is integrated into one or more processors.

Example 16 includes the device of any of Examples 1 to 14, wherein the controller is integrated into processing circuitry.

Example 17 includes the device of any of Examples 1 to 16, wherein the machine-learning audio encoder, the waveform-matching audio encoder, or both, are integrated into a processor.

Example 18 includes the device of any of Examples 1 to 17, wherein the controller, the machine-learning audio encoder, and the waveform-matching audio encoder are integrated in at least one of a mobile phone, a tablet computer device, a wearable electronic device, a camera device, a virtual reality headset, a mixed reality headset, or an augmented reality headset.

Example 19 includes the device of any of Examples 1 to 17, wherein the controller, the machine-learning audio encoder, and the waveform-matching audio encoder are integrated in a vehicle.

According to Example 20, a method includes obtaining, by one or more processors, an indication of a type of audio content associated with a segment of audio data; and selectively, based on the indication, causing the segment to be sent as input to a machine-learning audio encoder, a waveform-matching audio encoder, or both.

Example 21 includes the method of Example 20, further comprising using an audio classifier to generate the indication based on whether the segment represents audio content of a particular type.

Example 22 includes the method of Example 20 or Example 21, further comprising generating a bitstream representing an output of the machine-learning audio encoder, an output of the waveform-matching audio encoder, or both.

Example 23 includes the method of any of Examples 20 to 22, wherein the machine-learning audio encoder is configured to encode an input segment using a first number of bits, wherein the waveform-matching audio encoder is configured to encode an input segment using a second number of bits, and wherein the first number is less than the second number.

Example 24 includes the method of any of Examples 20 to 23, wherein each segment of the audio data is sent as input to a single audio encoder.

Example 25 includes the method of any of Examples 20 to 23 and further includes, based on a determination to transition which audio encoder is provided segments of the audio data, providing at least one segment of the audio data to both the machine-learning audio encoder and the waveform-matching audio encoder.

Example 26 includes the method of any of Examples 20 to 25 and further includes, when a particular audio encoder is selected to process two sequential segments of the audio data, processing a second segment of the two sequential segments using encoder state data resulting from processing a first segment of the two sequential segments, where the second segment is subsequent to the first segment.

Example 27 includes the method of any of Examples 20 to 26 and further includes, when different audio encoders are selected to process two sequential segments of the audio data, processing a second segment of the two sequential segments using default encoder state data, where the second segment is subsequent to the first segment.

Example 28 includes the method any of Examples 20 to 26 and further includes, when different audio encoders are selected to process two sequential segments of the audio data, processing, by a second audio encoder, a second segment of the two sequential segments using encoder state data based on a prior state of the second audio encoder, where the second segment is subsequent to the first segment.

Example 29 includes the method of any of Examples 20 to 26 and further includes, when different audio encoders are selected to process two sequential segments of the audio data, processing a second segment of the two sequential segments using encoder state data resulting from processing a first segment of the two sequential segments, where the second segment is subsequent to the first segment.

Example 30 includes the method of any of Examples 20 to 29 and further includes applying a first delay when transitioning to causing segments to be input to the waveform-matching audio encoder and applying a second delay when transitioning to causing segments to be input to the machine-learning audio encoder, wherein the first delay is different from the second delay.

Example 31 includes the method of Example 30, wherein the first delay is fixed and further comprising determining the second delay based on content of one or more of the segments.

According to Example 32, a non-transitory computer-readable medium stores instructions that are executable by one or more processors to cause the one or more processors to obtain an indication of a type of audio content associated with a segment of audio data; and selectively, based on the indication, cause the segment to be sent as input to a machine-learning audio encoder, a waveform-matching audio encoder, or both.

Example 33 includes the non-transitory computer-readable medium of Example 32, wherein the instructions are executable to cause the one or more processors to use an audio classifier to generate the indication based on whether the segment represents audio content of a particular type.

Example 34 includes the non-transitory computer-readable medium of Example 32 or Example 33, wherein the instructions are executable to cause the one or more processors to generate a bitstream representing an output of the machine-learning audio encoder, an output of the waveform-matching audio encoder, or both.

Example 35 includes the non-transitory computer-readable medium of any of Examples 32 to 34, wherein the machine-learning audio encoder is configured to encode an input segment using a first number of bits, wherein the waveform-matching audio encoder is configured to encode an input segment using a second number of bits, and wherein the first number is less than the second number.

Example 36 includes the non-transitory computer-readable medium of any of Examples 32 to 35, wherein the instructions are executable to cause the one or more processors to send each segment of the audio data as input to a single audio encoder.

Example 37 includes the non-transitory computer-readable medium of any of Examples 32 to 35, wherein the instructions are executable to cause the one or more processors to, based on a determination to transition which audio encoder is provided segments of the audio data, provide at least one segment of the audio data to both the machine-learning audio encoder and the waveform-matching audio encoder.

Example 38 includes the non-transitory computer-readable medium of any of Examples 32 to 37, wherein the instructions are executable to cause the one or more processors to, when a particular audio encoder is selected to process two sequential segments of the audio data, process a second segment of the two sequential segments using encoder state data resulting from processing a first segment of the two sequential segments, where the second segment is subsequent to the first segment.

Example 39 includes the non-transitory computer-readable medium of any of Examples 32 to 38, wherein the instructions are executable to cause the one or more processors to, when different audio encoders are selected to process two sequential segments of the audio data, process a second segment of the two sequential segments using default encoder state data, where the second segment is subsequent to the first segment.

Example 40 includes the non-transitory computer-readable medium any of Examples 32 to 38, wherein the instructions are executable to cause the one or more processors to, when different audio encoders are selected to process two sequential segments of the audio data, process, by a second audio encoder, a second segment of the two sequential segments using encoder state data based on a prior state of the second audio encoder, where the second segment is subsequent to the first segment.

Example 41 includes the non-transitory computer-readable medium of any of Examples 32 to 38, wherein the instructions are executable to cause the one or more processors to, when different audio encoders are selected to process two sequential segments of the audio data, process a second segment of the two sequential segments using encoder state data resulting from processing a first segment of the two sequential segments, where the second segment is subsequent to the first segment.

Example 42 includes the non-transitory computer-readable medium of any of Examples 32 to 41, wherein the instructions are executable to cause the one or more processors to apply a first delay when transitioning to causing segments to be input to the waveform-matching audio encoder and apply a second delay when transitioning to causing segments to be input to the machine-learning audio encoder, wherein the first delay is different from the second delay.

Example 43 includes the non-transitory computer-readable medium of Example 42, wherein the first delay is fixed and wherein the instructions are executable to cause the one or more processors to determine the second delay based on content of one or more of the segments.

According to Example 44, an apparatus includes means for obtaining an indication of a type of audio content associated with a segment of audio data; and means for selectively, based on the indication, causing the segment to be sent as input to a machine-learning audio encoder, a waveform-matching audio encoder, or both.

Example 45 includes the apparatus of Example 44, further comprising means for using an audio classifier to generate the indication based on whether the segment represents audio content of a particular type.

Example 46 includes the apparatus of Example 44 or Example 45, further comprising means for generating a bitstream representing an output of the machine-learning audio encoder, an output of the waveform-matching audio encoder, or both.

Example 47 includes the apparatus of any of Examples 44 to 46, wherein the machine-learning audio encoder is configured to encode an input segment using a first number of bits, wherein the waveform-matching audio encoder is configured to encode an input segment using a second number of bits, and wherein the first number is less than the second number.

Example 48 includes the apparatus of any of Examples 44 to 47, wherein each segment of the audio data is sent as input to a single audio encoder.

Example 49 includes the apparatus of any of Examples 44 to 47 and further includes means for providing at least one segment of the audio data to both the machine-learning audio encoder and the waveform-matching audio encoder based on a determination to transition which audio encoder is provided segments of the audio data.

Example 50 includes the apparatus of any of Examples 44 to 49 and further includes means for processing a second segment of two sequential segments using encoder state data resulting from processing a first segment of the two sequential segments when a particular audio encoder is selected to process the two sequential segments of the audio data, where the second segment is subsequent to the first segment.

Example 51 includes the apparatus of any of Examples 44 to 50 and further includes means for processing a second segment of two sequential segments using default encoder state data when different audio encoders are selected to process the two sequential segments of the audio data, where the second segment is subsequent to the first segment.

Example 52 includes the apparatus of any of Examples 44 to 50 and further includes means for processing, by a second audio encoder, a second segment of two sequential segments using encoder state data based on a prior state of the second audio encoder, where the second segment is subsequent to the first segment.

Example 53 includes the apparatus of any of Examples 44 to 50 and further includes means for processing a second segment of two sequential segments using encoder state data resulting from processing a first segment of the two sequential segments when different audio encoders are selected to process the two sequential segments of the audio data, where the second segment is subsequent to the first segment.

Example 54 includes the apparatus of any of Examples 44 to 53 and further includes means for applying a first delay when transitioning to causing segments to be input to the waveform-matching audio encoder and applying a second delay when transitioning to causing segments to be input to the machine-learning audio encoder, wherein the first delay is different from the second delay.

Example 55 includes the apparatus of Example 54, wherein the first delay is fixed and further comprising means for determining the second delay based on content of one or more of the segments.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a machine-learning audio encoder;
a waveform-matching audio encoder; and
a controller configured to cause a segment of audio data to be input to the machine-learning audio encoder, to the waveform-matching audio encoder, or to both, based on a classification associated with the segment.

2. The device of claim 1, further comprising an audio classifier configured to generate an indicator of the classification based on whether the segment represents audio content of a particular type and configured to provide the indicator to the controller.

3. The device of claim 1, further comprising a modem coupled to the machine-learning audio encoder and the waveform-matching audio encoder and configured to represent, in a bitstream, an output of the machine-learning audio encoder, an output of the waveform-matching audio encoder, or both.

4. The device of claim 1, wherein the machine-learning audio encoder is configured to encode an input segment using a first number of bits, wherein the waveform-matching audio encoder is configured to encode an input segment using a second number of bits, and wherein the first number is less than the second number.

5. The device of claim 1, wherein the controller is configured to select the machine-learning audio encoder to process a first set of segments that represent speech and to select the waveform-matching audio encoder to process a second set of segments that represent non-speech sounds.

6. The device of claim 1, wherein the controller is configured to select a single audio encoder to process each respective segment of the audio data.

7. The device of claim 1, wherein, when a particular audio encoder is selected to process two sequential segments of the audio data, encoder state data resulting from processing a first segment of the two sequential segments is used to process a second segment of the two sequential segments, where the second segment is subsequent to the first segment.

8. The device of claim 1, wherein, when different audio encoders are selected to process two sequential segments of the audio data, default encoder state data is used to process a second segment of the two sequential segments, where the second segment is subsequent to the first segment.

9. The device of claim 8, wherein, when different audio encoders are selected to process two sequential segments of the audio data, encoder state data used by a second audio encoder to process a second segment of the two sequential segments is based on a prior state of the second audio encoder, where the second segment is subsequent to the first segment.

10. The device of claim 1, wherein, when different audio encoders are selected to process two sequential segments of the audio data, encoder state data used to process a second segment of the two sequential segments is based on processing of a first segment of the two sequential segments, where the second segment is subsequent to the first segment.

11. The device of claim 1, wherein the controller is configured to use a first delay when transitioning to causing segments to be input to the waveform-matching audio encoder and is configured to use a second delay when transitioning to causing segments to be input to the machine-learning audio encoder, wherein the first delay is different from the second delay.

12. The device of claim 11, wherein the first delay is fixed and the second delay is variable and is selected based on content of the segments.

13. The device of claim 1, wherein the controller is configured to, in response to a determination to transition which audio encoder is provided segments of the audio data, provide at least one segment of the audio data to both the machine-learning audio encoder and the waveform-matching audio encoder.

14. The device of claim 13, further comprising a modem coupled to the machine-learning audio encoder and the waveform-matching audio encoder and configured to represent, in a bitstream, an output of the machine-learning audio encoder and an output of the waveform-matching audio encoder.

15. The device of claim 1, wherein the controller is integrated into one or more processors.

16. The device of claim 1, wherein the controller is integrated into processing circuitry.

17. The device of claim 1, wherein the machine-learning audio encoder, the waveform-matching audio encoder, or both, are integrated into a processor.

18. The device of claim 1, wherein the controller, the machine-learning audio encoder, and the waveform-matching audio encoder are integrated in at least one of a mobile phone, a tablet computer device, a wearable electronic device, a camera device, a virtual reality headset, a mixed reality headset, or an augmented reality headset.

19. The device of claim 1, wherein the controller, the machine-learning audio encoder, and the waveform-matching audio encoder are integrated in a vehicle.

20. A method comprising:
obtaining, by one or more processors, an indication of a type of audio content associated with a segment of audio data; and
selectively, based on the indication, causing the segment to be sent as input to a machine-learning audio encoder, a waveform-matching audio encoder, or both.

21. The method of claim 20, further comprising generating a bitstream representing an output of the machine-learning audio encoder, an output of the waveform-matching audio encoder, or both.

22. The method of claim 20, further comprising, when a particular audio encoder is selected to process two sequential segments of the audio data, processing a second segment of the two sequential segments using encoder state data resulting from processing a first segment of the two sequential segments, where the second segment is subsequent to the first segment.

23. The method of claim 20, further comprising, when different audio encoders are selected to process two sequential segments of the audio data, processing a second segment of the two sequential segments using encoder state data that is independent of processing a first segment of the two sequential segments, where the second segment is subsequent to the first segment.

24. The method of claim 20, further comprising, when different audio encoders are selected to process two sequential segments of the audio data, processing a second segment of the two sequential segments using encoder state data resulting from processing a first segment of the two sequential segments, where the second segment is subsequent to the first segment.

25. The method of claim 20, further comprising applying a first delay when transitioning to causing segments to be input to the waveform-matching audio encoder and applying a second delay when transitioning to causing segments to be input to the machine-learning audio encoder, wherein the first delay is different from the second delay.

26. The method of claim 20, further comprising, based on a determination to transition which audio encoder is provided segments of the audio data, providing at least one segment of the audio data to both the machine-learning audio encoder and the waveform-matching audio encoder.

27. A non-transitory computer-readable medium storing instructions that are executable by one or more processors to cause the one or more processors to:
obtain an indication of a type of audio content associated with a segment of audio data; and
selectively, based on the indication, cause the segment to be sent as input to a machine-learning audio encoder, a waveform-matching audio encoder, or both.

28. The non-transitory computer-readable medium of claim 27, wherein the instructions are executable to cause the one or more processors to apply a first delay when transitioning to causing segments to be input to the waveform-matching audio encoder and apply a second delay when transitioning to causing segments to be input to the machine-learning audio encoder, wherein the first delay is different from the second delay.

29. The non-transitory computer-readable medium of claim 27, wherein the instructions are executable to cause the one or more processors to, based on a determination to transition which audio encoder is provided segments of the audio data, provide at least one segment of the audio data to both the machine-learning audio encoder and the waveform-matching audio encoder.

30. An apparatus comprising:
means for obtaining an indication of a type of audio content associated with a segment of audio data; and
means for selectively, based on the indication, causing the segment to be sent as input to a machine-learning audio encoder, a waveform-matching audio encoder, or both.
